(19) United States
(12) Patent Application Publication
(10) Pub. No.: US 2007/0154365 A1
(43) Pub. Date: Jul. 5, 2007

(54) DISCHARGE CELL FOR OZONIZER

(75) Inventor: Takashi MATSUNO, Amagasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SUMITOMO PRECISION PRODUCTS CO., LTD., Amagasaki-shi (JP)

(21) Appl. No.: 11/563,393

(22) Filed: Nov. 27, 2006

(30) Foreign Application Priority Data
Nov. 29, 2005 (JP) 2005-343891
Dec. 27, 2005 (JP) 2005-375220

(51) Int. Cl. B01J 19/08

(52) U.S. Cl. 422/186.07

(57) ABSTRACT

To enable to reduce a manufacturing cost and to generate high-concentration ozone gas, in a plate-type discharge cell for ozonizer. To improve ozone concentration without depending on reduction of a gap amount in a discharge gap. Dispose dielectric bodies between a high-voltage electrode and a low-voltage electrode to form a discharge gap. On a back surface side of the high-voltage and the low-voltage electrodes, a high-voltage insulating plate and a low-voltage insulating plate are disposed, respectively, for insulating the electrodes and from cooling water. A thickness of the high-voltage insulating plate is set to not less than 0.5 times and not more than 3.5 times the total thickness of the dielectric bodies, which are disposed between the high-voltage and the low-voltage electrodes. Opposed surfaces of the dielectric bodies, which contact the discharge gap, are smoothed such that a roughness Ra thereof is not larger than 2 μm.

### BACKGROUND OF THE INVENTION

1. Field of the Invention

The present invention relates to a plate-type discharge cell used in an ozonizer.

2. Description of the Related Art

Discharge cells used in an ozonizer are classified broadly into a plate-type and a tube-type, and the plate-type discharge cells are subdivided into a circular plate-type and a square plate-type. The square plate-type discharge cell is often used for generating highly concentrated ozone, because a discharge gap formed between a pair of plate-like dielectric bodies may easily be narrowed and a dimension of the discharge gap may easily be equalized in a plane. A typical structure of the plate-like discharge cell will be described below.

Plate like dielectric bodies, each of which is formed of a square ceramic plate or the like, are disposed so as to be opposite to each other with a predetermined spacing therebetween. A pair of dielectric bodies have electrode layers, each of which is formed on a back side surface of each dielectric body so as to cover the same, thereby forming a discharge gap between the dielectric bodies. One of the pair of electrode layers is a high-voltage electrode and the other is a low-voltage electrode, and by applying a predetermined high-frequency high voltage between them, discharge is generated in the discharge gap between the dielectric bodies to ozonize material gas, which passes therethrough.

The discharge gap is generally forcedly cooled from both surface sides, in other words, from the back surface side of both electrodes, in order to improve efficiency of ozone generation. For the cooling from both surface sides, refrigerant flow paths are formed on each back surface side of the high-voltage electrode and the low-voltage electrode, through an insulating plate. And generally, a laminate-type cell, obtained by laminating a plurality of unit cells, each of which is the plate-type discharge cell having a structure cooled from the both surface sides, in a plate laminating direction, is used. One of such discharge cells is a ceramic block structure-type discharge cell, disclosed in Japanese Laid-Open Patent Application Publication No. H11-268902.

As a design factor in such plate-type discharge cell, there are a thickness of the pair of dielectric bodies disposed between the high-voltage electrode and the low-voltage electrode, a gap amount of the discharge gap formed between the pair of dielectric bodies, each thickness of the high-voltage insulating plate and the low-voltage insulating plate, disposed on the back surface side of the high-voltage electrode and the low-voltage electrode, respectively.

The dielectric bodies are intended to increase a dielectric constant between the electrodes for generating a silent discharge therebetween, and it is said that thinner dielectric body is better for shortening a distance between the electrodes to decrease the discharge voltage. However, when the dielectric body is too thin, flatness thereof is deteriorated and the like, so that at present, approximately 0.1 mm to 2 mm dielectric body are used.

In order to prevent material gas and ozone gas from contacting the electrode, the dielectric body is generally provided so as to contact both of the high-voltage electrode and the low-voltage electrode. That is to say, both electrodes are covered with the dielectric bodies and the discharge gap is formed between both dielectric bodies. However, in a case in which a cleanness of the ozone gas is not required, the discharge gap may be provided on one electrode side only (generally, on the high-voltage electrode side).

As for a gap amount of the discharge gap, it is said that the smaller gap amount is better for improving the ozone generating efficiency by cooling. From this viewpoint, the amount is made 0.4 mm or smaller at present, and a case of 0.1 mm or smaller is not rare.

As for the thickness of the insulating plate, the thickness of the high-voltage insulating plate is important. The high-voltage insulating plate is intended to electrically insulate an inner high-voltage electrode from an outer (back surface side) refrigerant (cooling water). If the high-voltage electrode is not sufficiently insulated from the cooling water on the back surface side, a reactive current flows to the back surface side cooling water, and the current to the discharge gap decreases, and as a result, the ozone generation efficiency is deteriorated. Therefore, the thickness of the high-voltage insulating plate is set to a few millimeters or more to be sufficiently thick, at present.

However, a thick high-voltage insulating plate is very expensive, and if this is thicker than 1 mm, this becomes drastically expensive, due to a manufacturing process thereof. An alumina plate or the like is used as the high-voltage insulating plate, and the plate not thicker than 1 mm are produced in large volume by using a doctor blade method or the like, so that the manufacturing cost thereof becomes low. However, the plate that is thicker than 1 mm should be manufactured by the manufacturing process such as casting or machining, so that this becomes drastically expensive.

Meanwhile, since the low-voltage electrode and the outer (back surface side) refrigerant (cooling water) are equipotent, the low-voltage insulating plate is not electrically required, instead, this is used in terms of preventing the refrigerant (cooling water) from directly contacting the low-voltage electrode, or of ensuring the mechanical strength. Therefore, the thick plate is not required, and the thin plate not thicker than 1 mm is generally used in view of economy, and a film-type plate may also be used.

In this manner, in the conventional discharge cell for ozonizer, it is essential to use the thick high-voltage insulating plate, and the increased cost of the insulating plate by using the same contributes to the increase of the discharge cell cost.

As for the gap amount of the discharge gap, as described above, it is said that the smaller one is better for improving the ozone generating efficiency by cooling, and from this viewpoint, the gap amount is made small so as not to be larger than 0.4 mm, at present, and the gap amount not larger than 0.1 mm (100 μm) also is realized. However, if the gap amount is made too small, the flatness of the surface (which contacts the discharge gap) of the dielectric body significantly negatively affects the in-plane evenness of the gap amount, and lowers the ozone concentration other way round. Due to such a secondary negative effect, the ozone concentration at present is limited approximately 300 g/m³ (N).

### SUMMARY OF THE INVENTION

An object of the present invention is to provide a high-performance and economic discharge cell for ozonizer, capable of reducing an insulating plate cost, while preventing an ozone generating efficiency from deteriorating.

Another object of the present invention is to provide the discharge cell for ozonizer, capable of increasing the ozone concentration without depending on a reduction of a gap amount in a discharge gap, and of more efficiently increasing the ozone concentration, when the gap amount is smaller.

The inventor has studied from sometime, an effect of a thickness of a dielectric body and a thickness of an insulating plate in a discharge cell for ozonizer, on an ozone generating efficiency. As a result, it has become clear that a thickness of an insulating plate, especially a thickness of a high-voltage insulating plate, which has contributed to increase a manufacturing cost of the discharge cell, is not essential in terms of the ozone generating efficiency, as this has been conventionally considered.

That is to say, the high-voltage insulating plate is intended to electrically insulate the inner high-voltage electrode from the outer (back surface side) refrigerant (cooling water), and if the sufficient thickness is not ensured, the reactive current flows to the refrigerant (cooling water) side and the discharge current in the discharge gap decreases, thereby deteriorating the ozone generating efficiency. However, on the other hand, the high-voltage insulating plate is disposed between the inner high-voltage electrode and the outer cooling water, and is the principal factor to block the cooling of the discharge gap by the cooling water from the high-voltage electrode side. Therefore, if the thin high-voltage insulating plate is used, the cooling from the high-voltage electrode side is accelerated, thereby improving the ozone generating efficiency.

That is to say, the thick high-voltage insulating plate is preferable in terms of the high-efficient discharge in the discharge gap, on the other hand, the thin plate is preferable in terms of the cooling of the discharge gap. And, the electrical aspect has been uniquely emphasized, and from this point of view, the high-voltage insulating plate has been made sufficiently thick so as not to be thinner than a few millimeters.

However, the result of the detailed convey, by the inventor of the present invention, of the relationship between the thickness of the high-voltage insulating plate and the ozone generating efficiency in the discharge cell for ozonizer was unexpected: when the high-voltage insulating plate is made thinner with the emphasis on the cooling of the discharge gap, although the electric loss in the discharge gap generates, the ozone generating efficiency in the discharge gap increases in totality, and as a result, the highly concentrated ozone gas may be obtained.

The inventor also attempts to approach from various viewpoints, to the increase of the ozone concentration in a discharge-type ozonizer, and devotes himself to the study of planning various measures, such as a device for improving the cooling capability by making the insulating plate on the high-voltage side thin, as well as formation of minute gap with high in-plane evenness, and of achieving the same. And, as a result of such research and development, the present inventor has found that a surface roughness of the dielectric body significantly affects the ozone concentration, especially, the ozone concentration under the minute gap.

Generally, the silent discharge in the discharge gap, required for generating ozone, occurs anytime at anywhere of the discharge gap, as a void column in a perpendicular direction, and the discharge in a small region adjacent to the surface of the dielectric body is said to contribute to generation of ozone. And, the generated discharge column is said to be better, if this is thick and stable.

On the other hand, as a material of the dielectric body, ceramic powder sintered body, such as high-purity alumina powder sintered body, is often used due to the increase in application, which requires clean gas. For example, in a case of the high-purity alumina powder sintered body, although alumina powder particles are exposed on a surface of the sintered body, the alumina powder is very minute, so that the surface of the sintered body looks smooth to the naked eye, and Ra is a few microns. However, if this is seen at the micro level, it is difficult to say that this is smooth.

When the surface of the dielectric body is rough, a tip end or the like of a convex portion becomes trigger and, thin and unstable discharge column is easy to be generated. If the gap amount of the discharge gap is large, the discharge column is formed in the large void, so that this does not significantly affect the ozone generating efficiency. However, if the gap amount of the discharge gap is small, the formation of the discharge column in the discharge gap cannot be expected, and the surface roughness of the dielectric body directly affects the wrong formation of the discharge column and the deterioration of the ozone generating efficiency due to the same.

The inventor of the present invention confirms from a number of experimental data using the discharge cell for ozonizer, the fact that as the surface of the dielectric body becomes smoother, the ozone concentration increases, and the tendency that the fact becomes significant as the gap amount in the discharge gap becomes small, and estimates the reason thereof as above.

The discharge cell for ozonizer of the present invention has been achieved based on such knowledge, and comprising dielectric body disposed between the high-voltage electrode and the low-voltage electrode, to each of which a predetermined alternating-current voltage is applied, so as to contact at least one of the electrodes, for forming the discharge gap between the electrodes; the refrigerant flow paths formed on the outer side of the both electrodes for cooling the discharge gap from both surface sides; and the high-voltage insulating plate disposed between the high-voltage side refrigerant flow path and the high-voltage electrode for insulating the former from the latter, wherein the thickness of the high-voltage insulating plate is made not less than 0.5 times and not more than 3.5 times the total thickness of the dielectric body disposed between the high-voltage electrode and the low-voltage electrode.

The discharge cell for ozonizer of the present invention is the discharge cell comprising the dielectric body disposed between the high-voltage electrode and the low-voltage electrode, to each of which the predetermined alternating-current voltage is applied, so as to contact at least one of the electrodes, for forming the discharge gap between the electrodes, wherein the roughness Ra of the surface of the dielectric body, which contacts the discharge gap, is set to 2 μm or smaller.

And the discharge cell for ozonizer of the present invention comprising a pair of dielectric bodies disposed between the high-voltage electrode and the low-voltage electrode, to each of which the predetermined alternating-current voltage is applied, so as to contact both electrodes, for forming the discharge gap between the electrodes, wherein the roughness Ra of each surface of both of the dielectric bodies, which contacts the discharge gap, is set not larger than 3 μm.

In the discharge cell for ozonizer of the present invention, the thickness of the high-voltage insulating plate is made thinner than that of the conventional one. More specifically, the plate is made thinner than before in a relationship between the same and the total thickness of the dielectric body, disposed between the high-voltage electrode and the low-voltage electrode, so that the cooling power in the discharge gap increases so as to outweigh the current loss, thereby improving the ozone generating efficiency. The legitimacy to relate the total thickness of the dielectric body and the thickness of the high-voltage insulating plate will be described in detail below.

The thickness of the high-voltage insulating plate is set not less than 0.5 times and not more than 3.5 times the total thickness of the dielectric body disposed between the high-voltage electrode and the low-voltage electrode. This is because in the case of less than 0.5 times, the reactive current to the back surface side (refrigerant side) increases to negate the improvement of efficiency by accelerating the cooling in the discharge gap, thereby deteriorating the ozone generating efficiency. And on the other hand, in the case of more than 3.5 times, the cooling from the high-voltage electrode side extremely lacks, so that although the reactive current does not substantially generate, the ozone generating efficiency as a whole deteriorates. A preferable scaling factor is not less than 0.5 times and not more than 2.0 times, and more preferably not less than 1.0 times and not more than 1.5 times.

The low-voltage insulating plate between the refrigerant flow path on the low-voltage side and the low-voltage electrode is not necessarily required. Because, the refrigerant flow path of the low-voltage side and the low-voltage electrode are equipotent (ground potential). In terms of accelerating the cooling from the low-voltage side and of the insulating plate cost, the low-voltage insulating plate is not required, and when using the same, the thin plate is preferred. However, in terms of ensuring the mechanical strength and of covering the low-voltage electrode, it is preferred that this exists, and it is preferred that the thickness thereof is not less than 0.1 mm and not more than 1 mm, and in a case in which the rigidity is not required, this may be in the order of a few micrometers (thin-film level). If this is too thick, the mechanical strength increases beyond necessity, so that the cooling power and the economic efficiency become worse.

And one more important thing is the fact that in the case of the discharge cell of the present invention in which the high-voltage insulating plate is made thin, the ozone concentration further increases by laminating a plurality of discharge cells. From this point of view, the laminated structure, obtained by laminating a plurality of unit cells, each of which is the discharge cell of the present invention in which the of thin high-voltage insulating plate is used, is preferable. In other words, the present invention is especially effective in the laminate-type cell, obtained by laminating the plurality of unit cells, each of which is the plate-type discharge cell having a structure that is cooled from both surface sides, in a plate laminating direction.

The dielectric body, the insulating plate, and the like are generally formed of ceramic. The ceramic is preferably alumina, of which degree of purity is not less than 80%, and alumina, of which degree of purity is not less than 90%, among others not less than 95% is especially preferable. The reason in which alumina is preferable is that, this is a material inexpensive as ceramic, and has chemical resistance and sputter resistance. And the reason in which the high purity is preferred is to improve cleanness of the ozone gas. As a jointing material used when laminating the ceramic plates, an inorganic jointing material is preferable, and as the inorganic jointing material, a glass-related jointing material is preferred in terms of jointing nature and contamination control. As the ceramic other than alumina, sapphire, SiC, AlN, or the like may also be used as the dielectric body, and as a material other than ceramic, quartz or the like may also be used.

As for the dielectric plate of the ceramic plates, when impurities in the dielectric plate are reduced, the ozone concentration problematically deteriorates. In order to solve the problem, titanic oxide may be contained in the dielectric plate at least in a surface layer portion thereof, which contacts the discharge gap, and the sintered body obtained by mixing 0.006 to 6 weight percent in Ti element content percentage of titanic oxide to the alumina substrate is especially preferred in terms of ozone generating property and of cleanness.

By performing the mirror-like finishing to the surface of the dielectric body, which contacts the discharge gap, such that the Ra is not more than 2 μm, the cell specification and the operational condition other than this are identical notwithstanding, the ozone concentration of the ozone gas to be generated increases. As the roughness Ra is smaller (smoother), the ozone concentration becomes higher, so that it is preferable that the Ra is not more than 1 μm, and more preferably, not more than 0.1 μm. Although the lower limit thereof is not specifically defined, there is technical and cost limitation in fabrication technique of the mirror-like finishing to smooth the surface of the dielectric body, so that this is limited in this aspect.

The relationship between the surface roughness of the dielectric body and the ozone concentration, more specifically, the tendency that the ozone concentration increases with the smoothing of the surface, becomes significant as the gap amount in the discharge gap becomes smaller. That is to say, the smoothing of the dialectic body surface is more effective when the gap of the discharge gap is smaller. From this point of view, smaller gap amount in the discharge gap is better, and specifically, the gap amount of not more than 150 μm is preferable, that of not more than 100 μm is more preferable than the case of 150 μm, that of not more than 50 μm is more preferable than the case of 100 μm, and that of not more than 35 μm is more preferable than the case of 50 μm. The reduction in gap amount is effective to obtain high concentration also in terms of cooling or the like. However, when the gap amount is reduced, the in-plane evenness is problematically lowered, and there is the limit in this aspect, as described above.

The surface roughness of the dielectric body varies depending on the material and structure thereof. The above-described ceramic sintered body and quartz melt, which have good performance as the dielectric body for generating ozone, are often used, however, the original surface thereof is relatively rough, so that the smoothing of the surface is especially effective. On the other hand, the amorphous glass is used as the dielectric body for generating ozone, the surface thereof is originally smooth, so that the effect of smoothing the surface is not large. From this point of view, the present invention is effective to dielectric body other than the amorphous glass, and is especially effective to the dielectric body formed of the ceramic sintered body and quarts melt.

As for an arrangement of the dielectric body, one dielectric body may be arranged between the high-voltage electrode and the low-voltage electrode so as to contact one of the electrodes, or a pair of dielectric bodies may be arranged so as to contact both of the electrodes. In both cases, it is required to control the roughness of the surface of the dielectric body, which contacts the discharge gap. The roughness of the opposite surface, that is to say, the surface that contacts the electrode is desired to be controlled to be smooth, in terms of the evenness of the dielectric efficiency.

In a case in which a pair of dielectric bodies are arranged so as to contact both of the high-voltage electrode and the low-voltage electrode, the control of the surface roughness of the dielectric body may be looser than in the case of arranging the dielectric body so as to contact one of the electrodes. That is to say, if the surface roughness Ra of the both dielectric bodies is made not more than 3 μm, an effect equivalent to the case in which one dielectric body is arranged and the surface roughness thereof is not more than 2 μm. From this point of view, the surface roughness Ra in the case in which both dielectric bodies are arranged is preferably not more than 3 μm, and it goes without saying that it becomes more preferable when the surface is smoother, such as not more than 2 μm, not more than 1 μm, not more than 0.1 μm.

As the mirror-like finishing to smooth the surface of the dielectric body, there is a lapping process, using a variety of slurries, or the like, for example.

A discharge cell for ozonizer of the present invention improves ozone generating efficiency and enables the ozone gas to be highly concentrated, by making a thickness of a high-voltage insulating plate, which insulates a high-voltage electrode from refrigerant of a high-voltage side, thinner than ever before in a relationship between the same and a total thickness of a dielectric body disposed between the high-voltage electrode and a low-voltage electrode. And, by reducing a thickness of the high-voltage insulating plate, a cost of the insulating plate is reduced, thereby enabling reduction of a discharge cell cost. By doing so, a high-performance and economic ozonizer may be provided.

The discharge cell for ozonizer of the present invention is capable of improving the ozone concentration without depending on a reduction of gap amount in the discharge gap, by smoothing a roughness Ra of the surface of the dielectric body disposed between the high-voltage electrode and the low-voltage electrode so as to contact at least one of the electrodes for forming the discharge gap between the electrodes, which contacts the discharge gap, to not to be more than 2 μm. If this is combined with the reduction of the gap amount, the ozone concentration may be more effectively improved.

### BRIEF DESCRIPTION OF THE DRAWINGS

FIG. 1 is an exploded perspective view of a discharge cell showing an embodiment of the present invention.

FIG. 2 is a schematic cross-sectional view of the discharge cell.

FIG. 3 is an equivalent circuit of the discharge cell.

### DETAILED DESCRIPTION OF THE PREFERRED EMBODIMENT

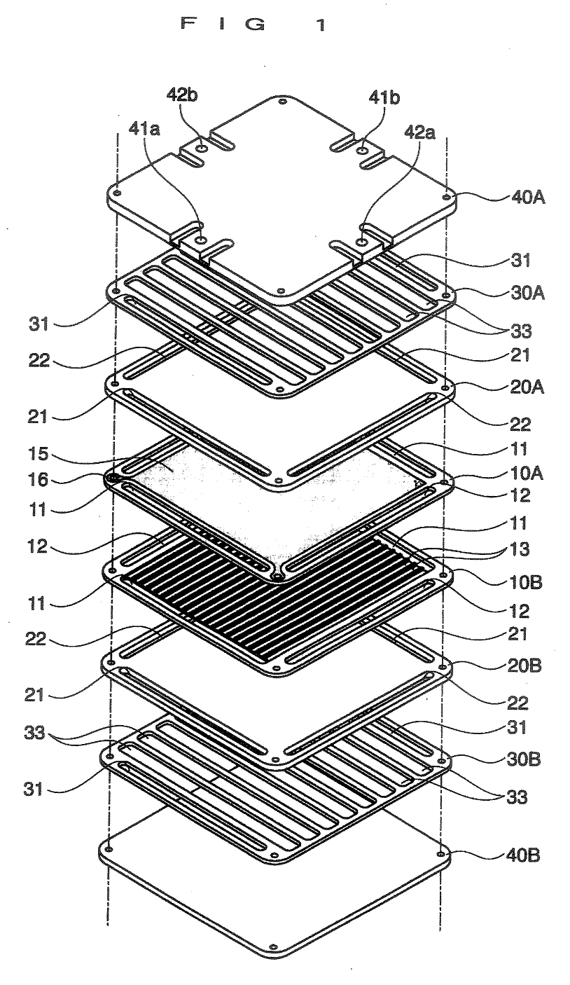

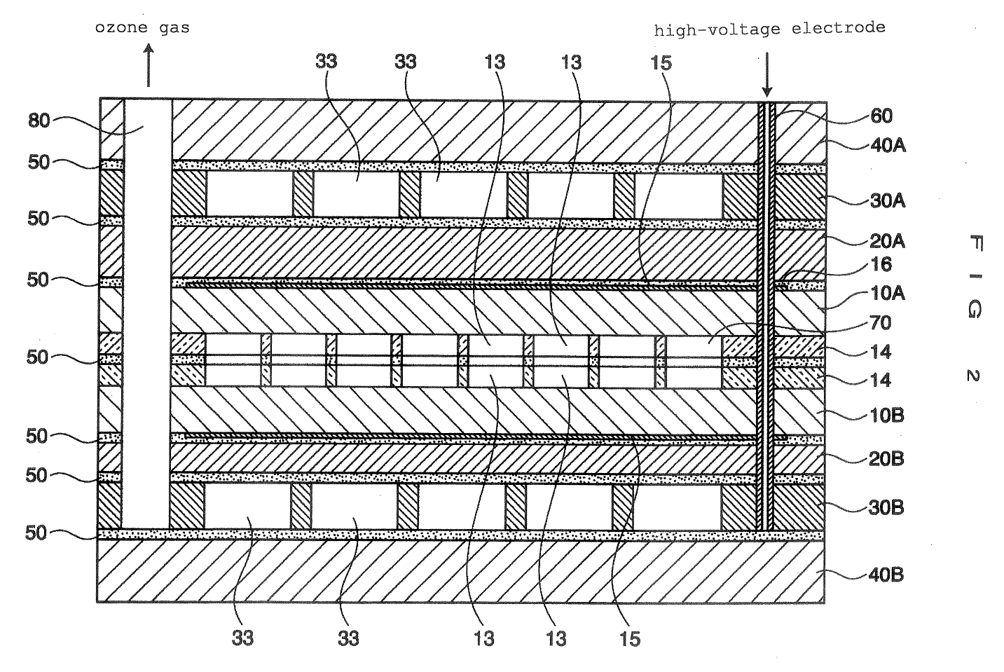

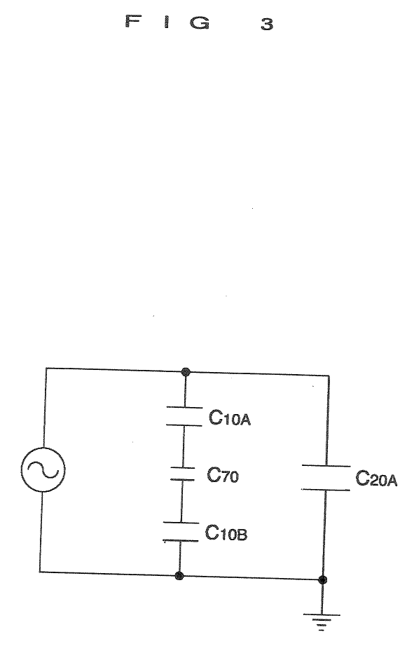

Hereinafter, an embodiment of the present invention will be described with reference to the drawings. FIG. 1 is an exploded perspective view of a discharge cell for ozonizer showing an embodiment of the present invention; FIG. 2 is a schematic cross-sectional view of the discharge cell; and FIG. 3 is an equivalent circuit of the discharge cell.

A plate-type discharge cell for ozonizer of this embodiment has a structure in which a plurality of square plates are laminated in a plate thickness direction, as shown in FIGS. 1 and 2. All of the plurality of plates are high-purity alumina baked plates, and are joined to each other by means of glass-related joining layers 50. Through holes for positioning are provided on four corners of each plate, and corner portions thereof are rounded off.

Two intermediate plates are dielectric bodies 10A and 10B. A thickness of each plate is 0.3 mm, for example. Surfaces of the dielectric bodies 10A and 10B, especially opposed surfaces thereof are mirror-like finished by applying a mirror-like finishing, such as lapping finish or the like, such that Ra is not more than 2 μm.

On both parallel side edge portions of each dielectric body 10, elongated through holes 11, 11 are provided so as to be along each side edge. The through holes 11, 11 are intended for gas circulation, and are continuously and linearly provided on substantially entire area of the both side edge portions except both end portions thereof. On other both parallel side edge portions of each dielectric body 10, that is to say, the both side edge portions perpendicular to the through holes 11, 11, elongated through holes 12, 12 are provided so as to be along each side edge. The through holes 12, 12 are intended for refrigerant circulation and are continuously and linearly provided on substantially entire area of the both side edge portions except both end portions thereof.

On the opposed surfaces of the dielectric bodies 10, 10, ceramic layers 14, 14 are laminated except portions of gas flow paths 13, 13, for forming a number of parallel gas flow paths 13, 13 extending from one side to the other side of the through holes 11, 11. The gas flow paths 13, 13 unite with each other to form a discharge gap 70 between the dielectric bodies 10, 10.

The ceramic layer 14 is formed by printing a paste, which is made of alumina powder and glass powder, on the opposed surface except the portions of the gas flow paths, until a predetermined thickness is obtained, and by baking the same at a temperature higher than a melting point of the glass powder. Each thickness of the ceramic layers 14, 14, that is to say, a rib height to form the gas flow paths is 35 μm, for example.

Electrode layers 15A and 15B are formed on backside surfaces of the dielectric bodies 10, 10, so as to cover the same. The electrode layer 15A is a high-voltage electrode and the electrode layer 15B is a low-voltage electrode, and each of them is formed of a metal thin-film, having a thickness of 5 μm, which is formed by print-applying and baking a silver paste, for example; and each of the layers is provided on a square region enclosed by through holes 11, 11 and 12, 12. The two adjacent corner portions of the electrode layer 15 protrude to the corner portions of the dielectric plate 10 to form circular terminal areas 16, 16. And, the terminal areas 16, 16 on one electrode layer 15A are provided on adjacent two corner portions of the dielectric plate 10A, and the terminal areas 16, 16 on the other electrode layer 15B are provided on other two adjacent corner portions of the dielectric body 10B so as not to overlap with the terminal areas 16, 16 of the electrode layer 15A.

The plates disposed on outer side of each of the dielectric bodies 11A and 10B are insulating plates 20A and 20B. The one insulating plate 20A is a high-voltage insulating plate and the other insulating plate 20B is a low-voltage insulating plate. The high-voltage insulating plate 20A is intended to insulate the inner high-voltage electrode 15A from outer refrigerant, and a thickness thereof is set to 0.9 mm, which is thinner than ever before, for example. The low-voltage insulating plate 20B is intended mainly to ensure a mechanical strength, and a thickness thereof is set to 0.3 mm, for example. That is to say, the thickness of the high-voltage insulating plate 20A is set to 1.5 times the total thickness (0.6 mm) of the dielectric bodies 10A and 10B, disposed between the electrode layers 15A and 15B.

Elongated through holes 21, 21 intended for gas circulation, which correspond to the through holes 11, 11, are provided on parallel both side edge portions of the insulating plates 20A and 20B. Elongated through holes 22, 22 intended for refrigerant circulation, which correspond to the through holes 12, 12, are provided on other parallel both side edge portions of each of the insulating plates 20A and 20B.

The plates disposed on outer side of each of the insulating plates 20A and 20B are slit plates 30A and 30B for forming refrigerant flow paths. A thickness of the slit plate is 0.5 mm, for example. Elongated through holes 31, 31, intended for gas circulation, which correspond to the through holes 11, 11, and 21, 21 are provided on the parallel both side edge portions of each slit plate 30. A number of slits 33, 33 . . . are provided in parallel between the through holes 31, 31, for forming the refrigerant flow paths. The both end portions of each of the slits 33, 33 . . . achieve to the other parallel both side edge portions so as to be overlapped with the through holes 22, 22, intended for refrigerant circulation.

The plates disposed on outer side of the slit plates 30A and 30B are lid plates 40A and 40B. A thickness of one lid plate 40A is 4 to 5 mm, for example, and a thickness of the other lid plate 40B is 2 mm, for example. On one lid plate 40A, a gas supply hole 41a and a gas discharge hole 41b, each of which communicates with the through holes 31, 31 of the inner slit plate 30A, respectively, are provided. On a back surface of the lid plate 40A, a pair of concave portions are provided so as to correspond to the both end portions of the slits 33, 33 . . . , in other words, the through holes 12, 12 and 22, 22. And on the lid plate 40A, a refrigerant supply hole 42a and a refrigerant discharge hole 42b, each of which communicates with a pair of concave portions on a back surface side, respectively, are provided.

The plates (high-purity alumina sintered plates) are joined in a following manner.

A glass-related joining paste is applied to joining surfaces of each plate in a thickness of 30 μm, for example. The joining paste is obtained by mixing the glass powder and binder and adjusting the same to have a predetermined viscosity After applying the joining paste, the plates are charged into a heating furnace and the joining paste is baked at a temperature of not lower than 850 degrees C., which is a melting point of the glass powder, for example. After baking the joining paste, the plates are overlapped one another and positioning pins 60 are pierced to the through holes at the four corner portions. The four positioning pins 60 are bar-type leads at the same time, and two of them conduct to the terminal areas 16, 16 of the high-voltage electrode layer 15A, and the other two conduct to the two terminal areas 16, 16 of the low-voltage electrode layer 15B. Finally, the overlapped plates are charged into the heating furnace and the joining paste is baked at a temperature of not lower than 850 degrees C., which is the melting point of the glass powder, for example.

By this baking, the dielectric bodies 10A and 10B, the insulating plates 20A and 20B disposed on the outer side of the plates 10A and 10B, the slit plates 30A and 30B disposed on the outer side of the plates 20A and 20B, and the lid plates 40A and 40B disposed on the outer side of the plate 30A and 30B are joined by means of the glass-related joining layers 50, and the discharge cell of this embodiment is completed. Features of the completed discharge cell are as follows.

By allowing the gas flow paths 13, 13 to unite with each other between the dielectric bodies 10A and 10B, a closed space for discharging, that is to say, a discharge gap 70 is formed between the dielectric bodies 10A and 10B. A thickness of each of the ceramic layers 14, 14, forming the gas flow paths 13, 13, is 35 μm, for example, and in this case, a gap amount of the discharge gap 70 becomes 70 μm. It is possible to omit one of the ceramic layers 14, 14, and in which case, the gap amount of the discharge gap 70 becomes 35 μm, which is a half thereof. The electrode layers 15A and 15B formed on the backside surfaces of the dielectric plates 10A and 10B so as to cover the same, are enclosed with the terminal areas 16, 16, between the dielectric plate 10 and the insulating plate 20, which is joined on the outer side of the plate 10, by means of the glass-related joining layer 50 and is insulated.

The terminal areas 16, 16 of the high-voltage electrode layer 15A, which is provided on the back surface of the dielectric layer 10A, are drawn out of the lid plate 40A by the two bar-like leads 60, 60 and are connected to a power supply. On the other hand, the terminal areas 16, 16 of the low-voltage electrode layer 15B, which is provided on the back surface of the dielectric plate 10B, are drawn out of the lid plate 40A by other two bar-like leads 60, 60, and are connected to ground.

The through holes 11, 11 of the dielectric body 10, the through holes 21, 21 of the insulating plate 20, and the through holes 31, 31 of the slit plate 30 are provided successively in a plate laminating direction, thereby allowing a vertical, horizontally wide gas flow paths 80, 80, which communicate with the discharge gap 70, to be formed in a laminated body. And the through holes 12, 12 of the dielectric body 10 and the through holes 22, 22 of the insulating plate 20 are provided successively in the plate laminating direction, thereby allowing a vertical, horizontally wide refrigerant flow paths, which communicate with the both end portions of the slits 33, 33 . . . of the slit plate 30, to be formed in the laminated body.

When operating the discharge cell, a predetermined high frequency high voltage is applied to the high-voltage electrode layer 15A, through the two bar-like leads 60, 60. At the same time, material gas is introduced from the gas supply hole 41a of the lid plate 40A into one of the two vertical gas flow paths 80, 80, formed in the laminating direction, and cooling water is introduced from the refrigerant supply hole 42a of the lid plate 40A into one of the two vertical refrigerant flow paths, formed in the laminating direction.

The material gas, introduced into one of the gas flow paths 80, 80, flows through the discharge gap 70, which is formed between the dielectric bodies 10A and 10B, from one end portion to the other end portion thereof, in doing so, the gas is ozonized and achieves the other of the gas flow paths 80, 80, and is discharged from the gas discharge hole 41b of the lid plate 40A to outside. The cooling water, introduced into one of the two refrigerant flow paths, flows through each of the slits 33, 33 . . . of the slit plates 30A and 30B in a longitudinal direction, passes through the other of the two refrigerant flow paths and is discharged from the refrigerant discharge hole 42b of the lid plate 40A. By doing so, the discharge gap 70 formed between the dielectric bodies 10A and 10B between the electrode layers 15A and 15B is cooled through the insulating plates 20A and 20B from both surface sides.

In the discharge cell of this embodiment, the predetermined high frequency high voltage is applied to the high-voltage electrode layer 15A, and the low-voltage electrode layer 15B is connected to ground with the cooling water. Therefore, the equivalent circuit in the discharge cell is as shown in FIG. 3. That is to say, the high-voltage insulating plate 20A is inserted in parallel to the series circuit of the dielectric body 10A, the discharge gap 70, and the dielectric body 10B. In the drawing, reference numeral C_{10A} indicates condenser capacity of the dielectric body 10A, C₇₀ indicates condenser capacity of the discharge gap 70, C_{10B} indicates condenser capacity of the dielectric body 10B, and C_{20A} indicates condenser capacity of the high-voltage insulating plate 20A. The condenser capacity C₇₀ of the discharge gap 70 is smaller than the condenser capacities C_{10A} and C_{10B} of the dielectric bodies 10A and 10B, respectively, and does not largely affect the condenser capacity of the series circuit. That is to say, the condenser capacity of the series circuit is controlled by the condenser capacities C_{10A} and C_{10B} of the dielectric bodies 10A and 10B, respectively.

When the high-voltage insulating plate 20A is as thick as before, the condenser capacity thereof is large and a reactive current to the cooling water of the high-voltage side is hardly generated. However, in this discharge cell, the high-voltage insulating plate 20A is made thinner than before. Specifically, the thickness of the insulating plate is set to 0.8 mm, which corresponds to nearly 1.5 times the total thickness (0.6 mm) of the dielectric bodies 10A and 10B disposed between the high-voltage electrode layer 15A and the low-voltage electrode layer 15B. Therefore, the condenser capacity of the high-voltage insulating plate 20A is reduced relative to a total capacity of the dielectric body 10A, the discharge gap 70 and the dielectric body 10B, so that generation of the reactive current to the cooling water of the high-voltage side becomes not negligible. However, since the voltage applied to the high-voltage electrode layer 15A is alternating current, electrical negative effect due to deterioration of the insulation property is relatively small. Instead, by the cooling water (cooling water of the high-voltage side) flowing through each of the slits 33, 33 . . . of the slit plate 30A, the discharge gap 70 between the dielectric bodies 10A and 10B is effectively cooled than ever before, and sufficiently compensates a loss due to the reactive current, so that ozone generating efficiency is improved, or, if not improved, the efficiency is not deteriorated.

That is to say, improvement in a power to cooling the void by a thinner high-voltage insulating plate 20A, and merit in the ozone generating efficiency balance out or transcend the reduction of the discharge current in the discharge gap 70 due to the deterioration of the insulation property and demerit in the ozone generating efficiency, and as a result, the ozone generating efficiency is improved or maintained.

Also, in the discharge cell of this embodiment, the opposed surfaces of the dielectric bodies 10A and 10B are smoothed such that Ra is not more than 2 μm. By this, a discharge column, which is generated in the discharge gap 70 between the dielectric bodies 10A and 10B, becomes thick and stable, and ozone concentration of generated ozone gas increases. The effect thereof is made clear with specific numeric values in a following example.

In addition, in the discharge cell of this embodiment, the material gas and the ozone gas flow from one of the vertical gas flow paths 80, 80 through the discharge gap 70 between the dielectric bodies 10A and 10B to the other of the vertical gas flow paths 80, 80. Herein, the vertical gas flow paths 80, 80 are formed in the laminating body, which is obtained by joining the high-purity alumina plates with the glass joining layers 50, and the high-purity alumina plate and the glass joining layers 50 are formed of clean inorganic non-metal materials, without containing contaminant source. And, the discharge gap 70 is formed of the ceramic layers 14 in a rib structure and the glass joining layer 50 between the dielectric bodies 10A and 10B formed of the high-purity alumina plate, and the ceramic layer 14 is formed of clean inorganic non-metal material as well as the glass joining layer 50. Further, the electrode layer 15 is enclosed between the dielectric plate 20 and the insulating plate 20, which is on a back side of the dielectric plate, by the glass joining layer 50.

Therefore, the material gas and the ozone gas do not directly contact metal, and pass through only the clean flow path, which is formed of the clean inorganic non-metal material, without containing the contaminant source. In other wards, all of gas contacting portions are formed of the clean material. So that, the material gas and the ozone gas are free from contamination by the discharge cell, and highly clean ozone gas is generated.

### First Embodiment

Next, the effect of the thickness of the high-voltage insulating plate in the discharge cell of the present invention on the ozone concentration is quantitatively indicated to clarify the effect of the present invention.

As a first example, the thickness of the high-voltage insulating plate 20A was variously changed in the discharge cell shown in FIGS. 1 and 2. Each thickness of the dielectric bodies 10A and 10B was set to 0.3 mm, and the total thickness was set to 0.6 mm. The gap amount in the discharge gap 70 was set to 35 μm, the thickness of the low-voltage insulating plate 20B was set to 0.3 mm, and each thickness of the slit plates 30A and 30B was set to 0.5 mm. The thickness of the high-voltage insulating plate 20A was set to 2 mm, 0.8 mm, and 0.3 mm, which was 3.3 times, 1.3 times and 0.5 times the total thickness (0.6 mm) of the dielectric bodies 10A and 10B, respectively.

The material gas was high-purity oxygen gas (6N), and a flow volume thereof was set to 0.5 L/min (N), and an inlet pressure was set to 0.25 MPa. The flow volume of the cooling water was set to 3 L/min, and the temperature thereof was set to 20 degrees C. The dielectric bodies 10A and 10B were made of TiO₂-doped alumina. A relationship between the discharge voltage and the ozone concentration is such that as the discharge voltage made larger, the ozone concentration increases, and the ozone concentration tends to decrease after its peak with a certain discharge voltage. The discharge voltage, which indicates the maximum ozone concentration, varies depending on a cell specification. In this case, the discharge voltage, in which the ozone concentration is the maximum when the thickness of the high-voltage insulating plate 20A was 0.8 mm, is set as a reference voltage, and the ozone concentration when the discharge voltage equals to the reference voltage was measured, and the relationship between the thickness of the high-voltage insulating plate 20A and the ozone concentration at this concentration was surveyed.

The ozone concentration was 348 g/m³(N) when the thickness of the high-voltage insulating plate 20A was 2 mm, 3.3 times the total thickness of the dielectric body, 357 g/m³ (N) when the thickness was 0.8 mm, 1.3 times the total thickness of the dielectric body, and 343 g/m³ (N) when the thickness was 0.3 mm, 0.5 times the total thickness of the dielectric body, respectively. From this, one can understand that reduction of the thickness of the high-voltage insulating plate does not cause decrease of the ozone concentration, and a cost of the insulating plate may be reduced by the reduction of the thickness.

As a second example, the gap amount in the discharge gap 70 was set to 70 μm. Other conditions were identical. The ozone concentration was 287 g/m³ (N) when the thickness of the high-voltage insulating plate 20A was 2 mm, 3.3 times the total thickness of the dielectric body, 282 g/m³ (N) when the thickness was 0.8 mm, 1.3 times the total thickness of the dielectric body, and 290 g/m³ (N) when the thickness was 0.3 mm, 0.5 times the total thickness of the dielectric body, respectively. In this case also, one can understand that the reduction in the thickness of the high-voltage insulating plate does not cause decrease of the ozone concentration, and the cost of the insulating plate may be reduced by the reduction of the thickness.

As a third example, the dielectric bodies 10A and 10B in the first example, the insulating plates 20A and 20B, disposed on outer side of the dielectric bodies, the slit plates 30A and 30B, disposed on outer side of the insulating plates, were made a unit cell, and ten unit cells were laminated and interposed between the lid plates 40A and 40B. Between the adjacent unit cells, the slit plates 30A and 30B were shared. The gap amount in the discharge gap 70 was 35 μm. Other conditions including the discharge voltage, the gas amount in the discharge gap 70, and the cooling water amount in the slit plates 30A and 30B were made identical to those of the first example.

The case in which the gap amount in the discharge gap 70 was 35 μm was compared. When a single-layer cell structure was changed to a ten layer cell structure, the ozone concentration increased from 348 g/m³(N) to 358 g/m³ (N) when the thickness of the high-voltage insulating plate 20A was 2 mm, from 357 g/m³ (N) to 405 g/m³ (N) when the thickness was 0.8 mm, and from 343 g/m³ (N) to 352 g/m³ (N) when the thickness was 0.3 mm, respectively.

As a fourth example, the dielectric bodies 10A and 10B, the insulating plates 20A and 20B disposed outside of the dielectric bodies, the slit plates 30A and 30B disposed outer side of the insulating plates, in the second example, were made a unit cell, and ten unit cells were laminated and interposed between the lid plates 40A and 40B. Between the adjacent unit cells, the slit plates 30A and 30B were shared. The gap amount in the discharge gap 70 was 70 μm. Other conditions including the discharge voltage, the gas amount in the discharge gap 70, and the cooling water amount in the slit plates 30A, 30B were made identical to those of the second example.

The case in which the gap amount in the discharge gap 70 was 35 μm was compared. In this case also, when the single-layer cell structure was changed to the ten layer cell structure, the ozone concentration increased from 287 g/m³ (N) to 297 g/m³ (N) when the thickness of the high-voltage insulating plate 20A was 2 mm, from 282 g/m³(N) to 325 g/m³ (N) when the thickness was 0.8 mm, and from 290 g/m³ (N) to 295 g/m³ (N) when the thickness was 0.3 mm, respectively.

As described above, although the reason thereof is not clear at this time, to form the discharge cell structure in multi layer is effective to improve the ozone concentration.

### Second Embodiment

Next, an effect of a surface roughness of the dielectric body in the discharge cell of the present invention on the ozone concentration is quantitatively indicated to clarify the effect of the present invention.

In the discharge cell shown in FIGS. 1 and 2, a roughness of the opposed surfaces of the dielectric bodies 10A and 10B was variously changed. The lapping finish was used as the mirror-like finishing to smooth the opposed surfaces, and the roughness was adjusted by changing a processing time. Without processing, the surface roughness Ra was 6.3 μm.

The dielectric bodies 10A and 10B were formed of TiO₂-doped alumina, and each thickness was set to 0.3 mm. The gap amount in the discharge gap 70 was set to 70 μm, the thickness of the low-voltage insulating plate 20B was set to 0.3 mm, the thickness of the high-voltage insulating plate 20A was set to 0.8 mm, and each thickness of the slit plates 30A and 30B was set to 0.5 mm, respectively.

The material gas was high-purity oxygen gas (6N), and the flow volume thereof was set to 0.5 L/min(N), and the inlet pressure thereof was set to 0.25 MPa. The flow volume of the cooling water was set to 3 L/min and the temperature thereof was set to 20 degrees C. The relationship between the discharge voltage and the ozone concentration is such that as the discharge voltage is made larger, the ozone concentration increases, and the ozone concentration tends to decrease after its peak with a certain discharge voltage. The ozone concentration was set to this maximum ozone concentration, and the discharge voltage to obtain the maximum ozone concentration, when the opposed surfaces of the dielectric bodies 10A and 10B were not processed, was set to 100.

When the roughness Ra of the opposed surfaces of the dielectric bodies without processing was 6.3 μm, the ozone concentration was 285 g/m³(N). When the opposed surfaces of the dielectric bodies were mirror-like finished such that the roughness Ra was 2 μm, the ozone concentration increased to 297 g/m³ (N), and the discharge voltage at the time decreased to 95. And when the opposed surfaces of the dielectric bodies were mirror-like finished such that the roughness Ra was 1 μm, to be smoother, the ozone concentration further increased to 304 g/m³ (N), and the discharge voltage at the time further decreased to 90.

The gap amount in the discharge gap 70 was set 35 μm. The cell specification other than this and the ozone generating condition were identical. The result is as follows.

When the roughness Ra of the opposed surfaces of the dielectric bodies without processing was 6.3 μm, the ozone concentration was 335 g/m³(N). When the opposed surfaces of the dielectric bodies were mirror-like finished such that the roughness Ra was 2 μm, the ozone concentration increased to 351 g/m³ (N), and the discharge voltage at the time decreased to 90. And when the opposed surfaces of the dielectric bodies were mirror-like finished such that the roughness Ra was 1 μm, to be smoother, the ozone concentration further increased to 372 g/m³ (N), and the discharge voltage at the time further decreased to 80.

Although the ozone concentration increases due to reduction of the gap amount, the effect of smoothing of the surfaces of the dielectric bodies on the increase of the ozone concentration is significant than that in the case in which the gap amount is 70 μm.

Although the embodiment shown in FIGS. 1 and 2 is square plate-type discharge cell, circular plate-type discharge cell may also be used. Although the dielectric bodies 10A and 10B are provided between the high-voltage electrode layer 15A and the low-voltage electric layer 15B so as to contact the electric layers 15A and 15B in the above-described embodiment, one of them may be omitted. And if enough cell strength is obtained in design, the low-voltage insulating plate 20B may also be omitted.

What is claimed is:

1. A discharge cell for ozonizer comprising: a dielectric body disposed between a high-voltage electrode and a low-voltage electrode, to each of which a predetermined alternating-current voltage is applied, so as to contact at least one of the electrodes, for forming a discharge gap therebetween; refrigerant flow paths formed on outer side of both electrodes for cooling the discharge gap from both surface sides; and a high-voltage insulating plate disposed between the refrigerant flow path on a high-voltage side and the high-voltage electrode for insulating the former from the latter, wherein a thickness of the high-voltage insulating plate is not less than 0.5 times and not more than 3.5 times the total thickness of the dielectric body disposed between the high-voltage electrode and the low-voltage electrode.

2. The discharge cell for ozonizer according to claim 1, wherein a pair of dielectric bodies are disposed between the high-voltage electrode and the low-voltage electrode so as to contact both electrodes and the discharge gap is formed between the pair of dielectric bodies.

3. The discharge cell for ozonizer according to claim 1, wherein a roughness Ra of a surface of said dielectric body, which contacts the discharge gap, is not more than 2 μm.

4. The discharge cell for ozonizer according to claim 1, wherein a pair of dielectric bodies are disposed between the high-voltage electrode and the low-voltage electrode so as to contact both electrodes, and the roughness Ra of each surface of both of the dielectric bodies, which contacts the discharge gap, is not more than 3 μm.

5. The discharge cell for ozonizer according to claim 1, wherein said dielectric body is formed of ceramic sintered body or quarts crystal.

6. The discharge cell for ozonizer, obtained by laminating a plurality of unit cells, each of which is the discharge cell for ozonizer according to claim 1.

7. A discharge cell for ozonizer comprising a dielectric body disposed between a high-voltage electrode and a low-voltage electrode, to each of which a predetermined alternating-current voltage is applied, so as to contact at least one of the electrodes, for forming a discharge gap between the electrodes, and a roughness Ra of a surface of said dielectric body, which contacts the discharge gap, is not more than 2 μm.

8. The discharge cell for ozonizer according to claim 7, wherein said dielectric body is formed of ceramic sintered body or quartz crystal.

9. A discharge cell for ozonizer comprising a pair of dielectric bodies disposed between a high-voltage electrode and a low-voltage electrode so as to contact both electrodes, for forming a discharge gap between the electrodes, and a roughness Ra of each surface of both of the dielectric bodies, which contacts the discharge gap, is not more than 3 μm.

10. A discharge cell for ozonizer according to claim 9, wherein said dielectric body is formed of ceramic sintered body or quartz crystal.
